(19) United States
(12) Patent Application Publication
(10) Pub. No.: US 2002/0030654 A1
(43) Pub. Date: Mar. 14, 2002

(54) Liquid crystal display

(75) Inventors: Koichi Igeta, Mobara (JP); Toshiki Asakura, Togane (JP); Masamitsu Furuie, Mobara (JP); Yasushi Iwakabe, Oamishirasato (JP)

Correspondence Address: Stanley P. Fisher, Reed Smith Hazel & Thomas LLP, 3110 Fairview Park Drive, Suite 1400, Falls Church, VA, 22042-4503, US

(73) Assignee: Hitachi, Ltd.

(21) Appl. No.: 09/949,902

(22) Filed: Sep. 12, 2001

(30) Foreign Application Priority Data
Sep. 14, 2000 (JP) 2000-279218

(51) Int. Cl. G09G 3/36

(52) U.S. Cl. 345/87

(57) ABSTRACT

Unwanted creation of an after-image in display images is significantly suppressing. A liquid crystal compound having either an ester structure or a heterocyclic structure with more than one oxygen atom is added to liquid crystal material at a mixture ratio of more than ten percent (10%).

### BACKGROUND OF THE INVENTION

1. Field of the Invention

The present invention relates to liquid crystal display devices and also relates to a liquid crystal display device called the lateral electric field scheme for example.

2. Description of the Related Art

Liquid crystal display devices called the lateral electric field scheme are typically arranged so that a pixel electrode and its associative opposite or “counter” electrode are formed in a respective one of liquid crystal-side pixel regions of one substrate of those substrates that are disposed to oppose each other with a layer of liquid crystal material interposed therebetween for permitting the liquid crystal's optical transmissivity to be controlled by certain components of an electric field as created between these respective electrodes in a substantially parallel direction to the substrate.

And, one of such liquid crystal display devices of the type stated above has been known in the art, which is designed so that the pixel electrode and the counter electrode are fabricated in different layers with a dielectric film(s) sandwiched therebetween, wherein one electrode is formed as a transparent electrode that is formed in a substantially entire region of the pixel region whereas the other electrode is formed as a plurality of stripe-shaped transparent electrodes extending in one direction along an almost entire region of the pixel region and being parallel-provided along this direction.

Additionally one example of such technology has been described in detail in, for example, S. H. Lee, S. L. Lee, H. Y. Kim, T. Y. Eom, SID 99 DIGEST, 202 (1999).

However, it has been pointed out that the liquid crystal display device of the type employing such arrangement suffers from a problem that accumulation of electrical charge carriers can readily take place due to the presence of an electric field at part adjacent to an electrode during driving thereof—even in the state that drive is turned off, the charge carrier accumulation will hardly be disappeared completely and thus can continue to reside therein.

With the presence of this charge accumulation, such will be applied to liquid crystal molecules causing the liquid crystal molecules to exhibit deviation from the initial alignment thereof, which would result in occurrence of undesired after-image phenomena.

### SUMMARY OF THE INVENTION

The present invention was made in view of the technical background stated above and its object is to provide a liquid crystal display device capable of significantly suppressing after-images.

A summary of a representative one of the inventive concepts as disclosed herein will be explained in brief below.

To be brief, the liquid crystal display device in accordance with the present invention is the one that is characterized by containing in a liquid crystal material a liquid crystal compound having more than one noncovalent or “unshared” electron pair or pairs.

The liquid crystal display device thus arranged is such that the unshared electron pair of the liquid crystal compound is readily ion-combinable with another ion while permitting the ion to exhibit sequential conduction (“hopping” conduction) from this unshared electron pair to another unshared electron pair(s) with relaxation of electrical charge carriers being done during this process.

It may be affirmed that such ion's hopping conduction is extremely faster in movement velocity or “migration” rate when compared to cases where movement of ions in other liquid crystals containing therein no such unshared electron pairs is carried out while repeating physical collision with liquid crystal molecules.

### BRIEF DESCRIPTION OF THE DRAWINGS

FIG. 1 is a graph and a table showing effects of a liquid crystal display device in accordance with the present invention;

FIG. 2 is a plan view diagram showing one embodiment of a pixel of the liquid crystal display device in accordance with this invention;

FIG. 3 is a cross-sectional diagram as taken along line III-III of FIG. 2;

FIG. 4 shows chemical formulae showing liquid crystal compounds containing an ester structure in liquid crystal material of the liquid crystal display device in accordance with the invention;

FIG. 5 shows chemical formulae or the like showing the meanings of symbols shown in FIG. 4 (and FIGS. 6 and 7);

FIG. 6 shows chemical formulae showing liquid crystal compounds containing a heterocyclic structure having more than one oxygen atom in the liquid crystal material of the liquid crystal display device in accordance with the invention;

FIG. 7 shows chemical formulae showing liquid crystal compounds containing a heterocyclic structure with one or more oxygen atoms in the liquid crystal material of the liquid crystal display device in accordance with the invention;

FIG. 8 is an explanation diagram showing hopping conduction of an ion due to the presence of a noncovalent or unshared electron pair(s);

FIG. 9 is a diagram showing an apparatus and a sample for obtaining experimental data showing effects of the instant invention;

FIG. 10 is a diagram showing measurement principles for obtaining experimental data showing effects of the invention and also measurement results;

FIG. 11 is a graph showing effects of the liquid crystal display device in accordance with the invention;

FIG. 12 is a graph showing effects of the liquid crystal display device in accordance with the invention;

FIG. 13 is a graph showing effects of the liquid crystal display device in accordance with the invention;

FIG. 14 is a graph showing effects of the liquid crystal display device in accordance with the invention;

FIG. 15 is a plan view diagram showing another embodiment of the pixel of the liquid crystal display device in accordance with the invention;

FIG. 16 is a plan view diagram showing still another embodiment of the pixel of the liquid crystal display device in accordance with the invention;

FIG. 17 is a plan view diagram showing yet another embodiment of the pixel of the liquid crystal display device in accordance with the invention; and

FIG. 18 is a plan view diagram showing a further embodiment of the pixel of the liquid crystal display device in accordance with the invention.

### DESCRIPTION OF THE PREFERRED EMBODIMENTS

Several embodiments of the liquid crystal display device in accordance with the present invention will now be set forth with reference to the accompanying drawings below.

Embodiment 1

(Pixel Arrangement)

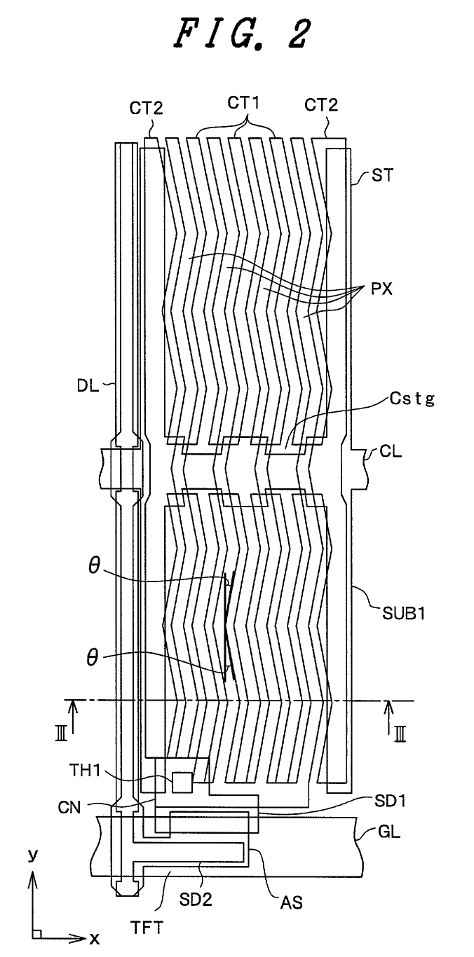

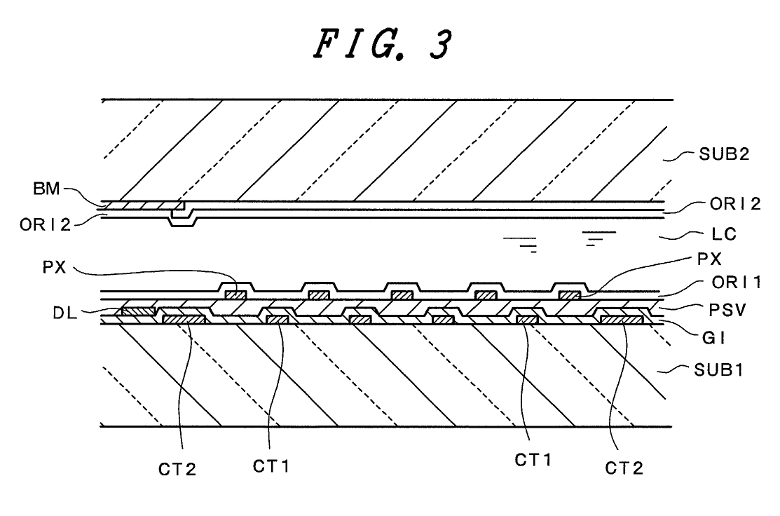

FIG. 2 is a plan view diagram showing one embodiment of a pixel of the liquid crystal display device in accordance with this invention. In addition, a cross-sectional view as taken along line III-III of FIG. 2 is shown in FIG. 3.

FIG. 2 is an arrangement diagram at a single pixel on a liquid crystal-side surface of one transparent substrate SUB1 of those transparent substrates which are disposed to oppose each other with a layer of liquid crystal material being interposed therebetween, wherein respective pixels are disposed into a matrix form. Due to this, other pixels that are placed at upper and lower portions or right and left portions of the pixel shown in this drawing are similar in arrangement to the illustrative one.

First of all, a gate signal line GL extending in an “x” direction in FIG. 2 is formed on the lower side of a pixel region which is part of a surface of the transparent substrate SUB1.

This gate signal line GL is formed in such a way as to surround the pixel region together with a corresponding gate signal line (not shown) of a pixel region that is placed on the upper side of the pixel region and a drain signal line DL as will be described later in the description plus a corresponding drain signal line of a pixel region being placed on the right side of the pixel region.

In addition, a counter voltage signal line CL extending in the x direction in the drawing is formed at a central portion of the pixel region. One example is that this counter voltage signal line CL is formed by the same process as that of the gate signal line GL; in the case of employing such arrangement, the material of such counter voltage signal line CL becomes the same as that of the gate signal line GL.

The counter voltage signal line CL is formed while letting a counter electrode CT be integral therewith, wherein this counter electrode CT is such that a plurality of ones are formed to extend in its upward/downward direction (“y” direction in FIG. 2) and parallel-provided in the x direction with the counter voltage signal line CL between them.

Additionally each counter electrode CT is formed to have a zigzag shape in the elongate direction thereof; regarding this, a detailed description will be presented later in conjunction with a pixel electrode(s) PX.

There is formed on the surface of the transparent substrate SUB1 with the gate signal line GL and counter voltage signal line CL (counter electrode CT) being formed in this way a dielectric film GI that is made for example of SiN or other similar suitable materials while also covering the gate signal line GL and counter voltage signal line CL (counter electrode CT).

This dielectric film GI is designed to have a function as an interlayer dielectric film with a drain signal line DL as will be described later with respect to the gate signal line GL and counter voltage signal line CL, a function as a gate insulation film with respect to a thin-film transistor TFT to be later described, and a function as a dielectric film with respect to a capacitive element Cstg to be described later.

And a semiconductor layer AS that is comprised for example of amorphous silicon (a-Si) is formed on an upper surface of the dielectric film GI at specific part overlapping a gate signal line.

This semiconductor layer AS is arranged so that it becomes a semiconductor layer of thin-film transistor TFT and also that forming on or over this upper surface a drain electrode SD2 and source electrode SD1 results in fabrication of a reverse stagger structured metal insulator semiconductor (MIS) transistor with part of the gate signal line GL being as its gate electrode.

Here, the drain electrode SD2 and source electrode SD1 are formed simultaneously during fabrication of the drain signal line DL by way of example.

More specifically the drain signal line DL extending in the y direction in the drawing is formed, a portion of which is extended in such case up to the upper surface of the semiconductor layer AS to thereby form the drain electrode SD2 while causing the source electrode SD1 to be formed at this drain electrode SD2 at part as spaced apart by a distance equivalent to the channel length of thin-film transistor TFT.

Here, the source electrode SD1 is designed so that it is connected to the pixel electrode PX via a protective film PSV as will be later described; thus, it is slightly extended toward the center side of the pixel region thereby forming a contact portion CN.

Formed over the surface of the transparent substrate SUB1 with the thin-film transistor TFT formed thereon in this way is the protective film PSV that is comprised for example of a resin film (or alternatively a SiN film, a SiN/resin film sequential multilayer body) or else while also covering the thin-film transistor TFT. This protective film PSV is formed mainly in order to avoid direct contact of the thin-film transistor TFT with the liquid crystal material used.

And a plurality of pixel electrodes PX that extend in the y direction in the drawing and are parallel-provided in the x direction are formed on an upper surface of this protective film PSV, wherein these pixel electrodes PX are formed in such a manner as to be disposed alternately while having a gap with each counter electrode CT stated supra.

These respective pixel electrodes PX are arranged to have a pattern which allows them to be mutually connected together in a region that overlaps the counter voltage signal line CL and are thus electrically connected while at the same time being each connected to the source electrode SD1 of a thin-film transistor TFT via a contact hole TH1 as formed in the protective film PSV.

With such an arrangement, an image signal from a drain signal line DL is arranged so that it is supplied to the pixel electrode PX via a thin-film transistor TFT that is driven by supplement of a scan signal from a gate signal line GL associated therewith. Additionally this pixel electrode PX is designed to create an electric field between itself and a counter electrode CT to which a signal for use as the reference is supplied.

Note that a mutual connection portion of respective pixel electrodes PX is arranged to form a capacitive element Cstg between it and the counter voltage signal line CL and thus has a function of letting the image signal be accumulated at the pixel electrode(s) PX for a relatively long time when the thin-film transistor TFT is turned off or similar functions thereto.

Here, each pixel electrode PX extending in the y direction in FIG. 2 is formed to have a zigzag shape along the length of from its one end to the other end in such a manner that it is bent into direction (relative to the y direction in the drawing) and thereafter bent in-direction (relative to the y direction in the drawing) and further bent in the direction (relative to the y direction in the drawing).

In the counter electrode CT also, it is bent in a similar way to that of the pixel electrode PX, wherein they are formed into a pattern which causes one electrode to overlap the other electrode as a result of shift in the x direction in the drawing.

The pixel electrode PX and counter electrode CT are designed to have such pattern because of employment of the so-called multi-domain scheme for forming a region in which the direction thereof is different in an electric field as created between the pixel electrode PX and counter electrode CT to thereby cancel out changes in color tone or “hue” in case observation is done from a different direction with respect to a display plane.

In addition, counter electrodes CT (CT2) that are placed on the both sides of a pixel region (in the lateral direction) are different in pattern from other counter electrodes CT (CT1) in such a manner that a side edge on the side of a neighboring drain signal line DL is parallel with the drain signal line DL while letting its width being relatively greater.

The reason is that this counter electrode CT2 has a function of making smaller the gap being defined between it and the drain signal line DL to thereby prevent undesired occurrence of light leakage and also has a shield function for precluding the end of an electric field from the drain signal line DL from terminating at the pixel electrode PX.

An orientation film ORI1 is formed over the surface of the transparent substrate SUB1 with the pixel electrodes PX being formed thereon in this way while also covering the pixel electrodes PX. This orientation film ORI1 is a film that is in direct contact with the liquid crystal LC for controlling the initial orientation or “alignment” directions of molecules of the liquid crystal LC, wherein its rubbing direction is identical to the extension direction of drain signal line DL in case the liquid crystal is of p type and identical to the extension direction of gate signal line GL in case the liquid crystal is n type.

In addition a black matrix BM is formed over the liquid crystal-side surface of a transparent substrate SUB2 which is disposed to oppose the transparent substrate SUB1 thus arranged as stated above with the liquid crystal LC interposed therebetween in such a manner as to partition neighboring pixels with color filters FIL of corresponding colors being formed at aperture sections (these functions as substantial pixel regions) of this black matrix BM.

And an orientation film ORI2 is formed to cover these black matrix BM and color filters FIL also, wherein the rubbing direction of this orientation film ORI2 is the same as that of the orientation film on the side of the transparent substrate SUB1.

Note that although in the above-noted arrangement any one of the pixel electrode PX and counter electrode CT may be the one that is formed of an opaque metal comprising for example Cr (or its alloys) or the like, at least one of them may be a transparent metal comprising indium-tin-oxide (ITO) or else, by way of example.

Additionally in case the pixel electrode PX and counter electrode CT are formed of transparent metals, the so-called aperture ratio of pixels will be greatly improved.

(Liquid Crystal Material) Materials for preferable use as the layer of liquid crystal LC as interposed between the respective transparent substrate SUB1, SUB2 that are disposed to oppose each other may typically include a liquid crystal material containing therein a liquid crystal compound including an ester structure or alternatively a liquid crystal material containing a liquid crystal compound including a heterocyclic structure having more than one oxygen atom.

And such liquid crystals are preferably of n type in order to improve optical transmissivities.

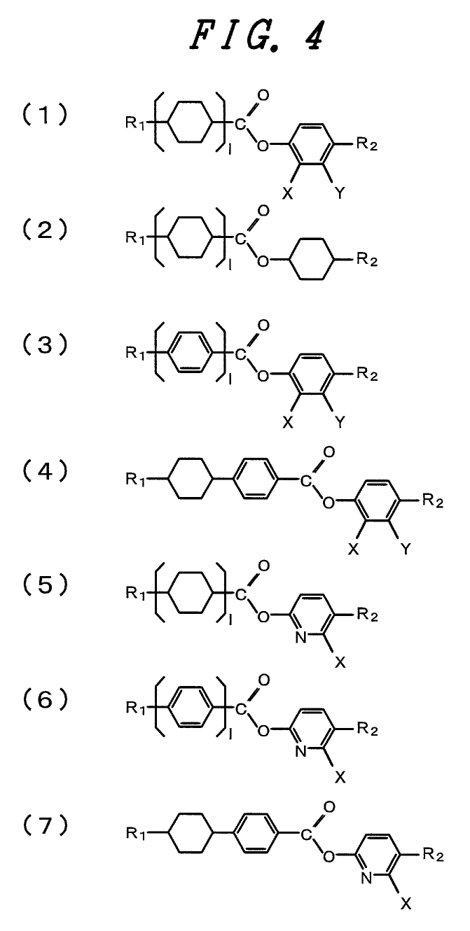

Some representative examples of the liquid crystal compound including the ester structure are shown in respective ones of (1) to (7) of FIG. 4.

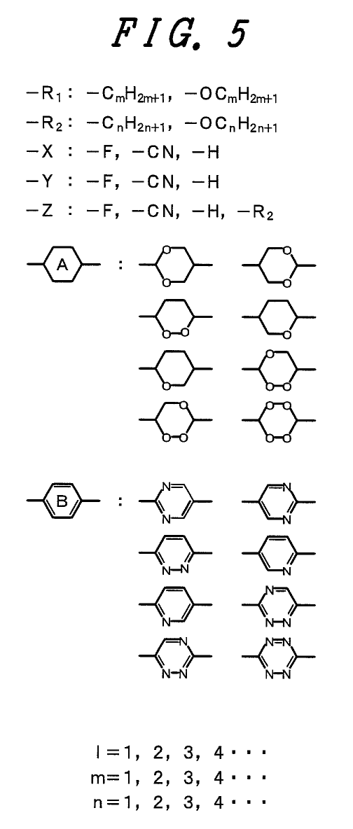

Here, as shown in FIG. 5, —R₁ of FIG. 4 for example indicates —CₘH₂ₘ₁ or alternatively —OCₘH₂ₘ₊₁; in addition, it shows m=1, 2, 3, 4, . . . , and other symbols are based on those shown in FIG. 5.

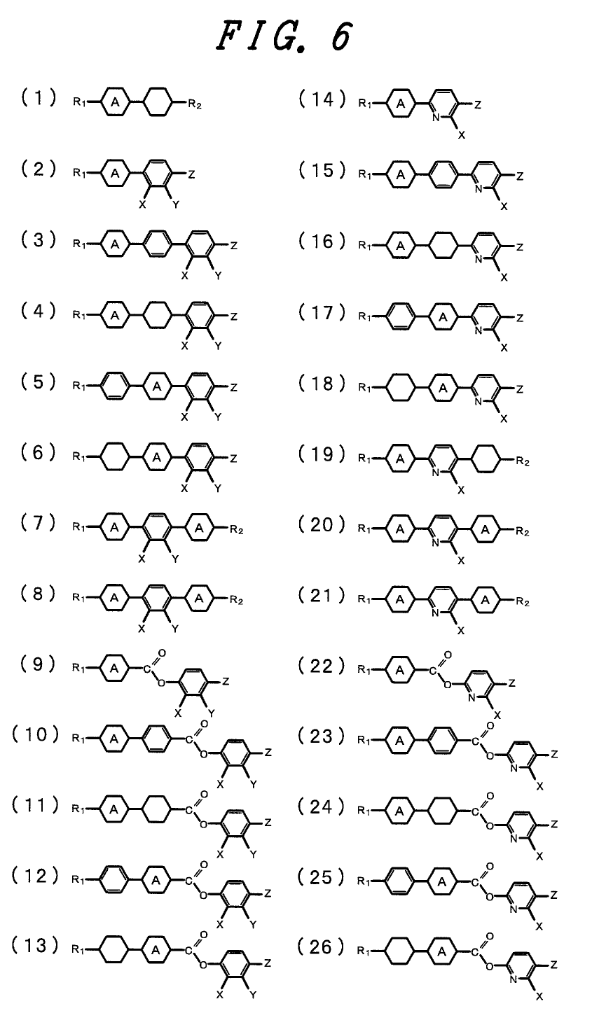

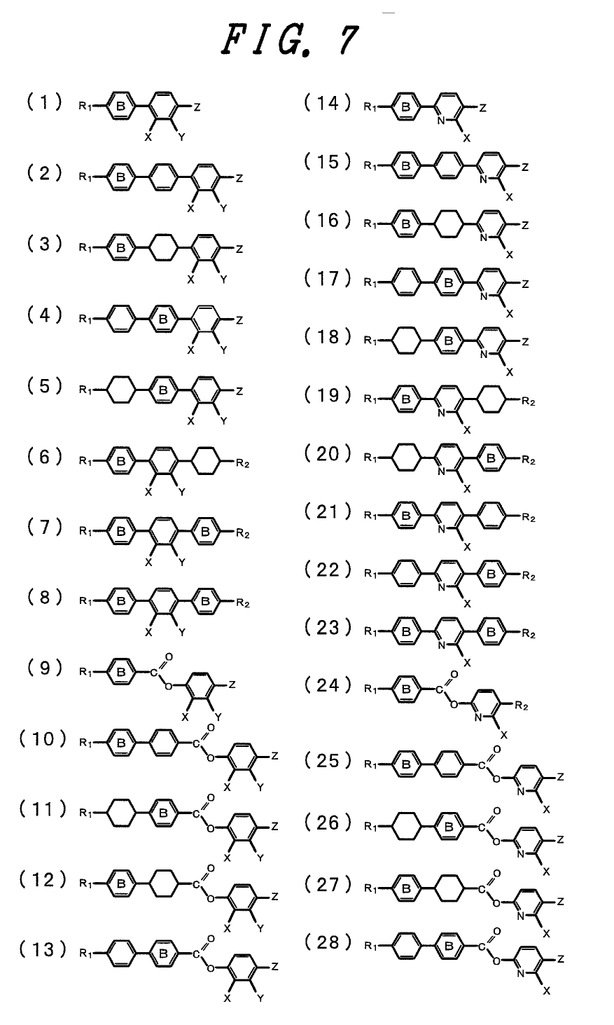

Additionally, representative examples of the liquid crystal compound including the heterocyclic structure having more than one oxygen atom are shown in respective ones of (1) through (26) of FIG. 6 whereas other representative examples of the liquid crystal compound having a noncovalent or unshared electron pair(s) are shown in respective ones of (1) to (28) of FIG. 7.

In this case also, as shown in FIG. 5, —R₁ of FIG. 4 for example indicates —CₘH₂ₘ₊₁ or alternatively —OCₘH₂ₘ₊₁; in addition, it shows m=1, 2, 3, 4, . . . , and other symbols are based on those shown in FIG. 5.

Such liquid crystals LC offer the functionality for attracting an ion or ions that is/are present within liquid crystals because of the presence of more than one electrical charge carrier of the negative polarity at an unshared electron pair as contained in an oxygen atom (O) forming the ester structure or alternatively at an unshared electron pair included in a hetero atom such as oxygen atom forming the heterocyclic structure. An electric field due to the unshared electron pair is inherently weak so that any strong coupling will no longer occur between an attracted ion and the unshared electron pair. For the very reason, it becomes possible for such ion to sequentially move or “travel” toward neighboring unshared electron pairs. Owing to such ion travel form, the ion movement or “migration” within the liquid crystal is accelerated thus making it possible to rapidly relax those charge carriers being presently accumulated at or near electrodes.

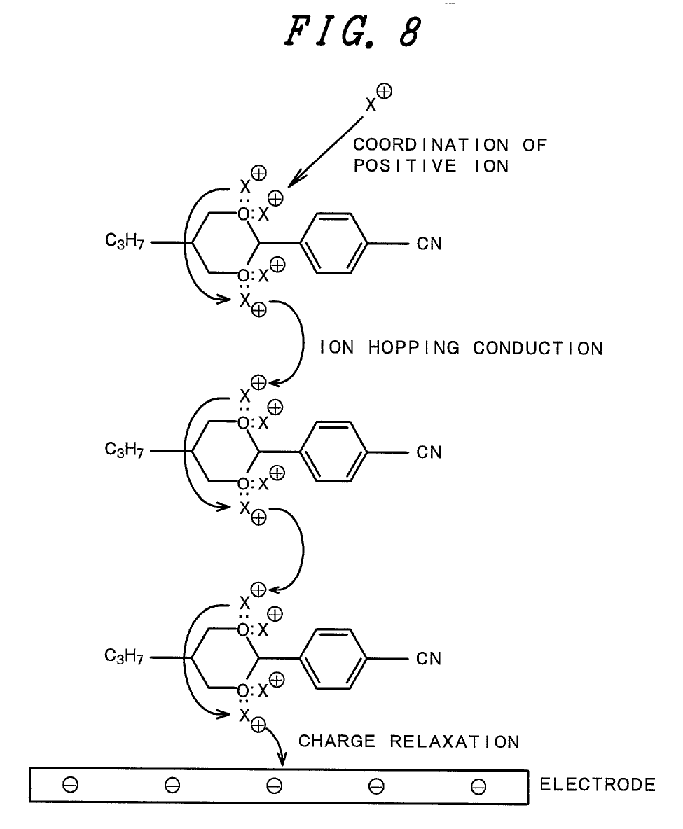

FIG. 8 is a pictorial representation diagram showing the way of relaxing charge carriers as accumulated near electrodes due to ion migration (ion's hopping conduction) in the liquid crystal compound containing the heterocyclic structure having one or more oxygen atoms by way of example. Oxygen atoms (O) having unshared electron pairs are contained in liquid crystal molecules including the heterocyclic structure having oxygen atoms. Since at an unshared electron pair that exists on such oxygen atoms it is electrified with charge of the negative polarity, an ion that is present within the liquid crystal behaves to sequentially move from this unshared electron pair to its neighboring unshared electron pair, thereby achieving relaxation of charge accumulated near electrodes during this process.

It has been affirmed that such ion hopping conduction is fast in travel speed when compared to the fact that charged particle movement in other liquid crystals that do not contain the ester structure or the heterocyclic structure having an oxygen atom(s) is done while repeating physical collision with liquid crystal molecules.

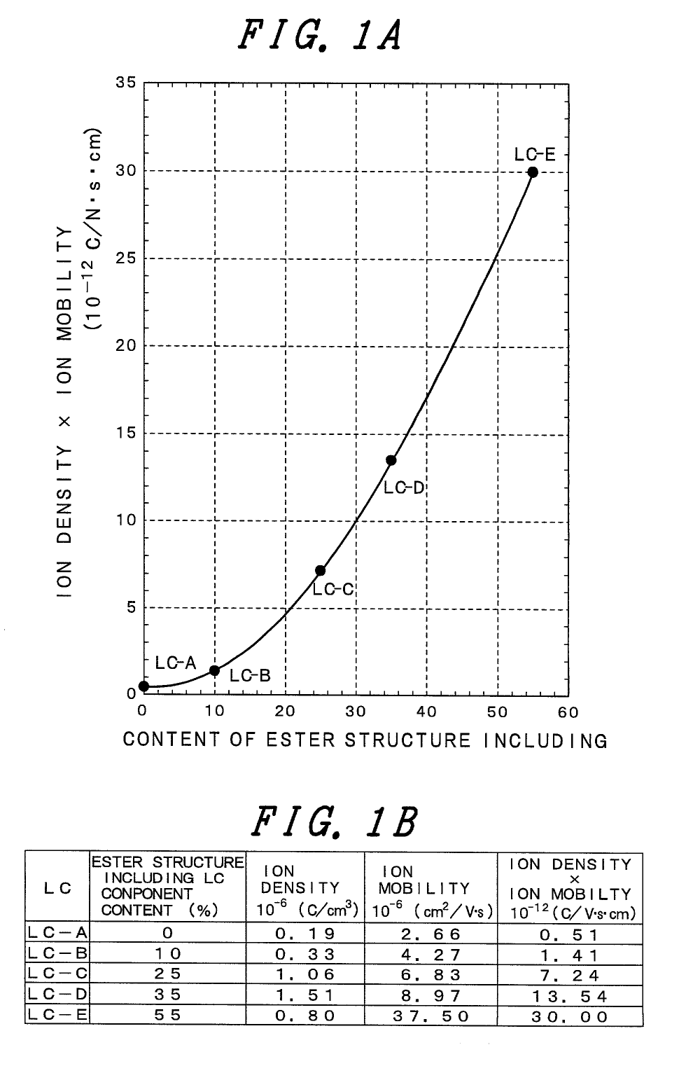

FIG. 1A is an experimental graph showing ion movement or “migration” based on the amount of content of a liquid crystal component including the ester structure in relation with the density of such ions in a liquid crystal display device employing the liquid crystal compound including the ester structure by way of example.

In this graph the ester structure-including liquid crystal component content (%) is plotted along its lateral axis whereas the ion density×ion mobility (10⁻¹²C/V·s·cm) is taken along the longitudinal axis thereof.

The ester structure-including liquid crystal component content is shown in FIG. 1A as 0% (indicated by LC-A in the drawing), 10% (indicated by LC-B in the drawing), 25% (indicated by LC-C in the drawing), 35% (indicated by LC-D in the drawing), and 55% (indicated by LC-E in the drawing); a respective one of the ion density and ion mobility in such cases is recited in FIG. 1B as a separate table.

Also note that the amount of “ion density×ion mobility” indicates the ion's ability to move or travel through the liquid crystal, which shows that ion movement is done more efficiently with an increase in ion density and also with an increase in ion mobility at that time. In brief, it would be readily understandable that it works more effectively for relaxation of charge carriers when the value of the ion density×ion mobility becomes greater.

It can be seen from this graph that setting the content of the liquid crystal component including the ester structure at 10% or greater results in the ion density×ion mobility becoming more than or equal to 1.41×10⁻¹²C/V·s·cm, which in turn permits ion movement to be done far more effectively as compared to the case of the complete absence of any liquid crystal components including the ester structure as included therein (0.51×10⁻¹²C/V·s·cm).

Whereas the value of the ion density×ion mobility does not change significantly while the content of the liquid crystal component including the ester structure is between 0% and 10%, the value of ion density×ion mobility becomes greater rapidly when the content of the ester structure-including liquid crystal component is set at 10% or greater. This phenomenon is resulted from the fact that the ion's hopping conduction works more efficiently with the setting of the content of the ester structure-including liquid crystal component at 10% or more. In other words, it shows that in the liquid crystal material with the content of the ester structure-including liquid crystal component being set at less than 10%, an ion being presently coupled with an unshared electron pair is incapable, when moving toward another unshared electron pair, of finding any appropriate unshared electron pair at nearby locations thereof due to the fact that the content of the ester structure-including liquid crystal components stays less, resulting in failure of efficient execution of the ion hopping conduction. However, setting the content of such ester structure-including liquid crystal component at 10% or greater makes it possible for the ion being coupled with the unshared electron pair to efficiently move or travel toward another unshared electron pair, resulting in a rapid increase in value of the ion density×ion mobility.

This result suggests that setting the content of the ester structure-including liquid crystal component at 10% or more enables the intended ion hopping conduction to be carried out efficiently thereby making it possible to rapidly relax any electrical charge carriers as accumulated near electrodes.

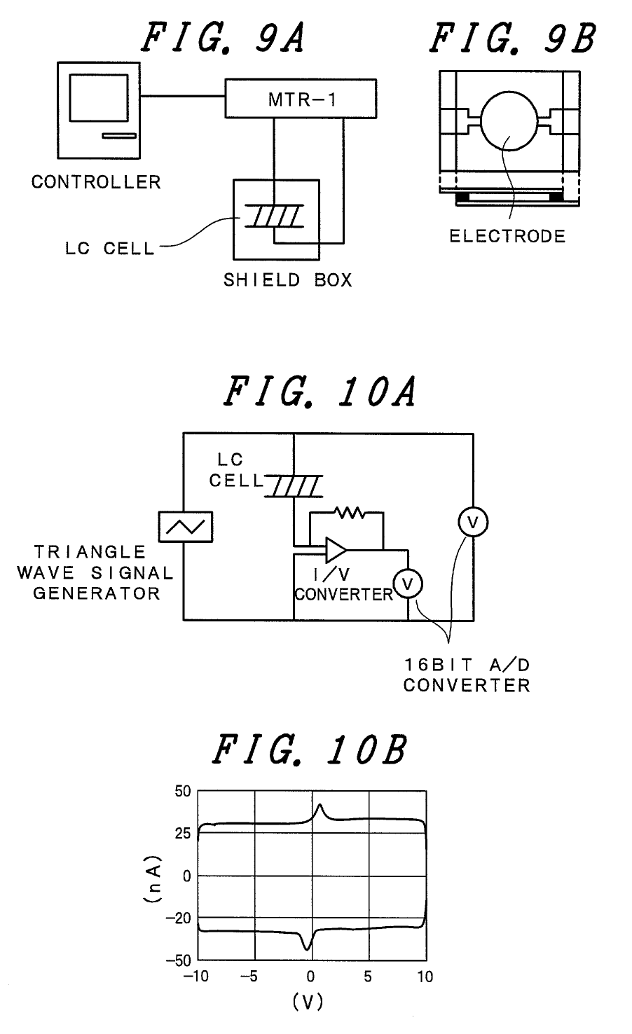

It should be noted that the experimentation for obtaining the above-noted graph was done by using MTR-1 type liquid crystal cell/ion density measurement apparatus (manufactured by Toyo Corporation) as shown in FIG. 9A for obtaining data from a liquid crystal cell within a shield box under the control of a controller.

As shown in FIG. 9B the liquid crystal cell used for measurement was prepared in such a way as to ensure establishment of the same condition as the arrangement of a pixel section of the above-noted liquid crystal display device, which is then used as a sample. The electrode area is set at 3.14 cm² whereas the electrode distance was at 5.5 μm.

Measurement principles are such that in a circuit diagram of the MTR-1 type liquid crystal cell/ion density measurement apparatus shown in FIG. 10A a low frequency triangle wave voltage is applied to the liquid crystal cell and a resultant current in such case was measured by a 16-bit A/D converter after having converting it into a voltage by use of an I/V converter. In addition a voltage being applied to the liquid crystal cell was also measured by 16-bit A/D converter and then its current value and voltage value were plotted thus obtaining a current-voltage waveform shown in FIG. 10B.

FIG. 10B takes the voltage value of triangle wave voltage along its lateral axis while taking its current value along the longitudinal axis thereof. As the area of a peak upon application of the triangle voltage becomes the total charge amount of an ion that have moved between electrodes, it is possible to know from the peak area a total number of movable ions existing in the liquid crystal under an assumption that the ion's valence number is 1. Additionally the peak area is obtained by letting it be subject to triangle fitting.

The ion density is obtainable by the equation (1) which follows:

Ion Density=P/(S·d) (1)

In addition the ion mobility is obtainable by the next equation (2):

Ion Mobility=d²/(½)tE (2)

where P is the peak area (total charge amount of ions that have moved between electrodes) (C), S is the electrode area (cm²), d is the electrode distance (cm), t is the ion peak generation time (sec), and E is the ion peak generation voltage (V).

Additionally the above measurement was done at a measurement frequency of 0.1 Hz with a measurement voltage being set at −10 to 10 V at a measurement temperature of 25° C.

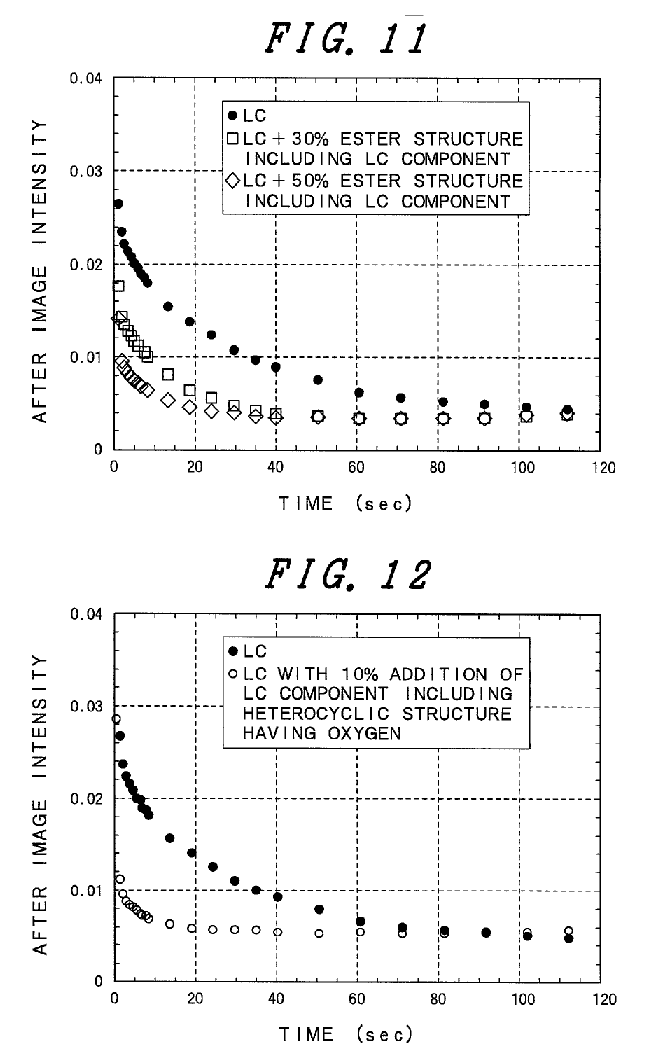

FIG. 11 is a graph showing a change with time in afterimage intensity of a liquid crystal display device using a liquid crystal compound including the ester structure. It shows the case of adding the ester structure-including liquid crystal component at 30% and the case of addition at 50% in comparison with the case of a related art (does not contain such ester structure-including liquid crystal component).

It is apparent from this drawing that in case the liquid crystal component including the ester structure is sufficiently added or mixed, the resultant afterimage intensity behaves to rapidly decrease or attenuate thus finally reaching a certain constant value, and also that this value becomes a smaller value when compared to the related art.

As has been explained previously, in case the liquid crystal component including the ester structure is added at 10% or greater, at unshared electron pairs as included in oxygen atoms (O) forming the ester structure, it becomes possible for an ion that is present within the liquid crystal to sequentially move to neighboring unshared electron pairs; thus, the ion movement or migration will be done rapidly. As a result of this, it becomes possible to rapidly relax those charge carriers being accumulated near electrodes, which in turn enables rapid attenuation of the afterimage intensity.

In addition, FIG. 12 is a drawing corresponding to FIG. 11, which is a graph showing a change with time in afterimage intensity of a liquid crystal display device using a liquid crystal compound including the heterocyclic structure having more than one oxygen atom. It shows the case of adding the liquid crystal component including the heterocyclic structure having more than one oxygen atom at 10% in comparison with the case of a related art (does not contain such liquid crystal component including the heterocyclic structure having more than one oxygen atom).

It would be apparent from this diagram also that in case the liquid crystal component including the heterocyclic structure having more than one oxygen atom is added, the afterimage intensity attenuates rapidly.

This phenomena is also such that as has been explained supra, in case the liquid crystal component including the heterocyclic structure having more than one oxygen atom is added, at unshared electron pairs as included in oxygen atoms (O) forming the heterocyclic structure, it becomes possible for an ion that is present within the liquid crystal to sequentially move to neighboring unshared electron pairs; thus, the ion movement will be done rapidly. This makes it possible to rapidly relax those charge carriers being accumulated near electrodes, which in turn enables rapid attenuation of the afterimage intensity.

It should be noted here that while the ion mobility tends to become greater with an increase in amount of either the liquid crystal component including the ester structure or the liquid crystal component including the heterocyclic structure having more than one oxygen atom, it has been affirmed that adversely the liquid crystal increases in threshold voltage causing an afterimage to tend to readily take place. The cause of this is such that more than one oxygen atom (O) as included in either the liquid crystal compound including the ester structure or the liquid crystal compound including the heterocyclic structure having more than one oxygen atom is charged with less amount of negative charge owing to the workability of one or more unshared electron pairs existing therein so that it serves to attract ions being present within the liquid crystal material. However, if the content of the liquid crystal component including the ester structure or alternatively the liquid crystal compound including the heterocyclic structure having more than one oxygen atom increases then it takes thereinto or “accommodates” an excess amount of ionic impurities from the periphery thereof; thus, it is assumed that this results in an increase or rise-up of the threshold voltage due to the presence of such ionic impurities thereby causing display defects of the liquid crystal display device to occur unwantedly.

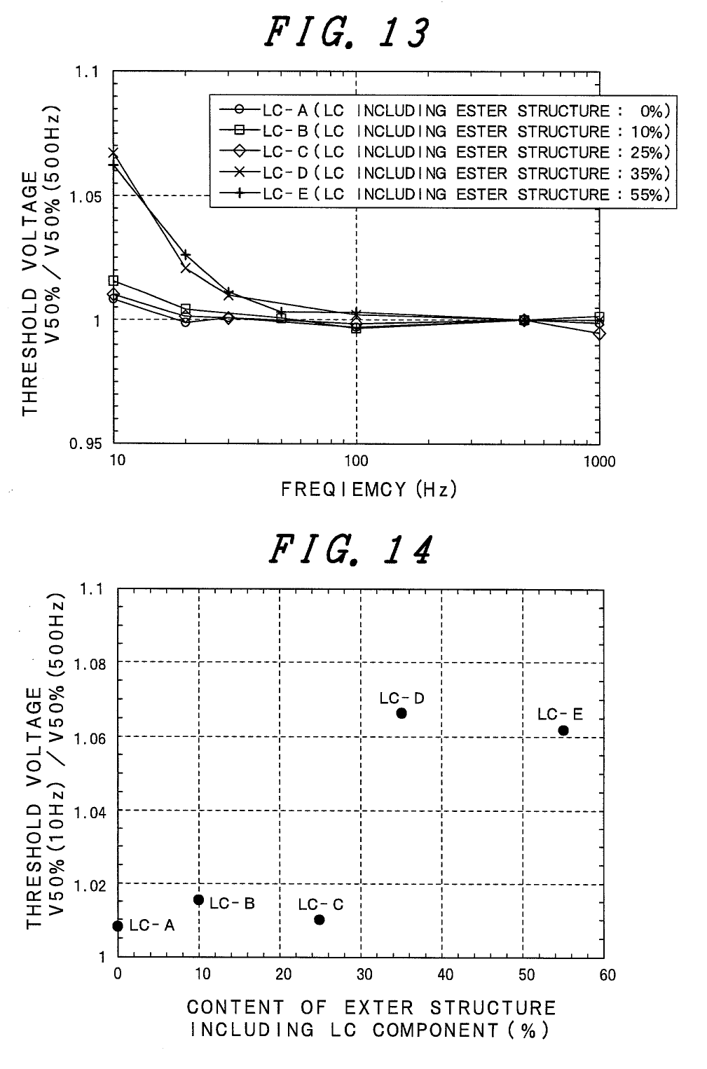

FIG. 13 is a graph showing a change in liquid crystal's threshold voltage with respect to a signal frequency between a pixel electrode and counter electrode due to differences (0%, 10%, 25%, 35%, 55%) of the content of the liquid crystal component including the ester structure, which graph shows such signal frequency along its lateral axis while indicating in the longitudinal axis a relative threshold voltage (V50%/V50%(500 Hz)) as obtained by standardization of a threshold voltage (V50%) giving 50% of a maximal brightness or luminance by V50% at 500 Hz. As apparent from this drawing, it would be understandable that the threshold voltage is especially significant in variation within a region of low frequencies.

And, based on this graph, in the low frequency region, a graph taking the content of the liquid crystal component including the ester structure along its lateral axis while taking along its longitudinal axis the relative threshold voltage (V50%(10 Hz)/V50%(500 Hz)) as obtained by standardization of V50% at 10 Hz by V50% at 500 Hz becomes as shown in FIG. 14, wherein the content of the ester structure-including liquid crystal component exhibits the fact that the largeness and smallness of a threshold voltage of the liquid crystal is clearly separated with 30% being as a boundary.

When the content of the liquid crystal component including the ester structure exceeds 30%, it accommodates thereinto an excess amount of ionic impurities from the periphery thereof, resulting in assumption of occurrence of a variation in threshold voltage.

From this, it becomes apparent that it is preferable to set the content of the liquid crystal component including the ester structure at 30% or less from a view point of suppression of generation of display defects of the liquid crystal display device due to such variation of the liquid crystal's threshold voltage.

Such a phenomenon was similar also in the case of the liquid crystal component including the heterocyclic structure having more than one oxygen atom.

Embodiment 2

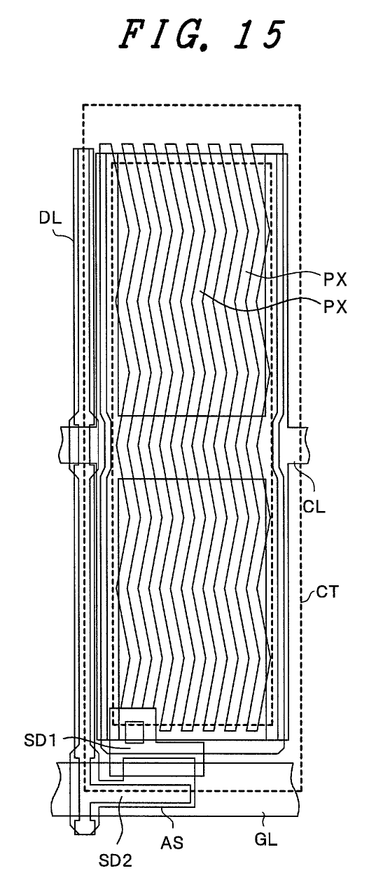

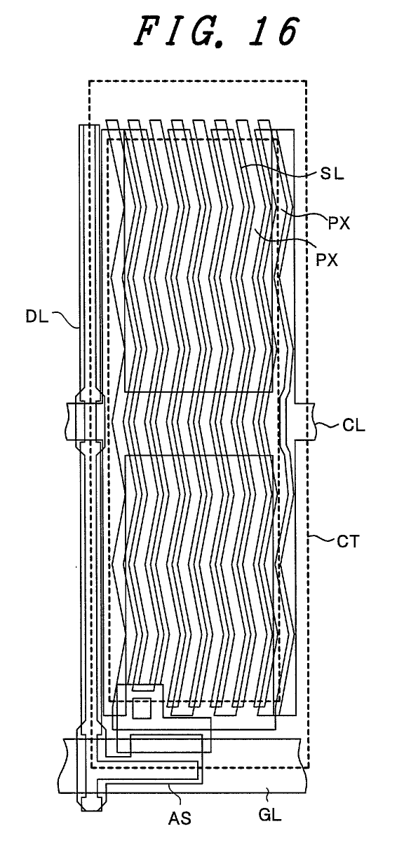

FIG. 15 is a plan view diagram showing another embodiment of the arrangement of the liquid crystal display device in accordance with the present invention.

The band-like pixel electrodes PX and counter electrodes CT as formed in each pixel of the liquid crystal display device shown in the embodiment 1 are such that these are spaced apart from each other and disposed alternately.

However it may also be applied even with an arrangement that either one of the pixel electrode PX and counter electrode CT is formed in an overall region of a pixel region.

FIG. 15 is a diagram corresponding to FIG. 2, wherein the counter electrode CT is arranged to be formed in the overall region of the pixel region and wherein the others are arranged in substantially the same way as that of FIG. 2.

In this case the counter electrode is required to be formed of a transparent electrode such as ITO for example whereas the pixel electrode may be either a transparent electrode or an opaque electrode.

Embodiment 3

FIG. 16 is a plan view diagram showing still another embodiment of the arrangement of the liquid crystal display device in accordance with the instant invention.

This diagram is a diagram corresponding to FIG. 15, wherein at the counter electrode CT as formed in an overall region of a pixel region, an opening or hole SL having a larger width than the width of a pixel electrode PX is formed in a region corresponding to the formation region of pixel electrodes PX as formed alternately for example (may also be at every two other ones or at every other three ones).

This arrangement is an arrangement with the arrangement of the embodiment 1 and the arrangement of the embodiment 3 being combined together. The invention may also be applied to the liquid crystal display device of the type employing such arrangement.

It must be noted that in this case also, the counter electrode is required to be formed of a transparent electrode such as ITO as an example whereas the pixel electrode may be either a transparent electrode or an opaque electrode.

Embodiment 4

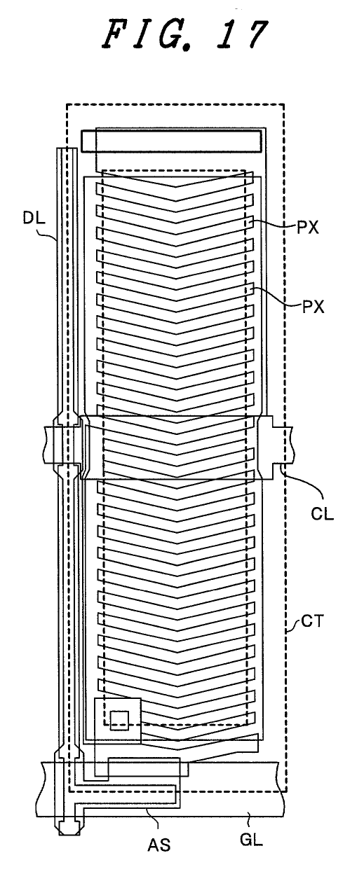

FIG. 17 is a plan view diagram showing yet another embodiment of the arrangement of the liquid crystal display device in accordance with the present invention.

This diagram is such that a plurality of pixel electrodes PX are formed which extend in a direction almost at right angles to a drain signal line DL, wherein these respective pixel electrodes PX are connected together at specified ends thereof.

Each pixel electrode PX in this case is formed so that it is bent at substantially the center of its extension direction to thereby form a region which makes different the direction of an electric field as produced between the pixel electrode PX and counter electrode CT, thus becoming an arrangement that employs what is called the multi-domain scheme.

The counter electrode CT is formed entirely in the pixel region and is formed of a transparent electrode made of ITO or the like, by way of example.

Embodiment 5

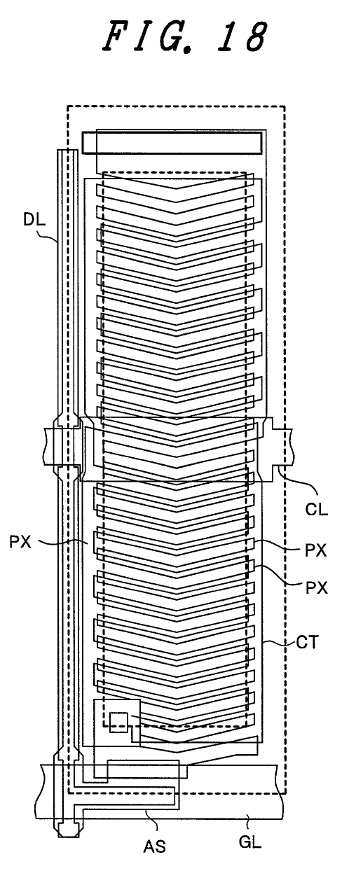

FIG. 18 is a plan view diagram showing a further embodiment of the arrangement of the liquid crystal display device in accordance with the present invention.

This diagram is a diagram corresponding to FIG. 17, wherein at the counter electrode CT as formed in an overall region of a pixel region, an opening or hole having a larger width than the width of a pixel electrode PX is formed in a region corresponding to the formation region of pixel electrodes PX as formed alternately for example (may also be at every two other ones or at every other three ones).

As has been apparent from the above explanation, according to the liquid crystal display device in accordance with the present invention, it is possible to significantly suppress any unwanted creation of afterimages in on-screen display images thereof.

What is claimed is:

1. A liquid crystal display device comprising a liquid crystal compound having more than one unshared electron pair, contained in a liquid crystal material.

2. A liquid crystal display device comprising a liquid crystal compound having an ester structure, contained in a liquid crystal material.

3. A liquid crystal display device comprising a liquid crystal compound having a heterocyclic structure with more than one oxygen atom, contained in a liquid crystal material.

4. A liquid crystal display device comprising a liquid crystal compound having one of an ester structure and a heterocyclic structure with more than one oxygen atom, added to a liquid crystal material at a ratio of 10% or greater.

5. The liquid crystal display device according to claim 4, wherein a liquid crystal compound having one of an ester structure and a heterocyclic structure with more than one oxygen atom is added to the liquid crystal material at a ratio of 30% or less.

6. A liquid crystal display device comprising a liquid crystal material having an n conductivity type as a result of addition of a liquid crystal compound thereto at a ratio of 10% or more, the liquid crystal compound having one of an ester structure and a heterocyclic structure with more than one oxygen atom.

7. A liquid crystal display device comprising a liquid crystal compound having one of an ester structure and a heterocyclic structure with more than one oxygen atom, added to a liquid crystal material at a ratio of 30% or less.

8. The liquid crystal display device according to any one of the preceding claims 1 to 7, wherein:
a pixel electrode and a counter electrode are formed with a dielectric film laid therebetween in a liquid crystal side pixel region of one substrate of those substrates as disposed to oppose each other with a liquid crystal material interposed therebetween; and
one electrode of these pixel electrode and counter electrode is comprised of a transparent electrode as formed entirely in the pixel region, whereas a remaining electrode thereof is extended in one direction and parallel-provided in a direction at right angles to said direction.

9. The liquid crystal display device according to any one of the preceding claims 1 to 7, wherein:
a pixel electrode and a counter electrode are formed with a dielectric film laid therebetween in a liquid crystal side pixel region of one substrate of those substrates as disposed to oppose each other with a liquid crystal material interposed therebetween; and
these pixel electrode and counter electrode comprise a plurality of electrodes extending in one direction and being parallel-provided in a direction at right angles to said direction, and they are disposed alternately.

10. The liquid crystal display device according to any one of the preceding claims 8 and 9, wherein:
a switching element as driven by supplement of a scan signal from a gate signal line is further provided; and
an image signal from a drain signal line is supplied via this switching element to the pixel electrode.
